(19) United States
(12) Patent Application Publication
(10) Pub. No.: US 2006/0137752 A1
(43) Pub. Date: Jun. 29, 2006

(54) Control device for controlling the movements in a multi-way valve for driving a cylinder-piston assembly

(76) Inventor: Paolo Rusconi, Gera d'Adda (IT)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/266,746

(22) Filed: Nov. 3, 2005

(30) Foreign Application Priority Data
Dec. 28, 2004 (IT) MI2004A-002527

(51) Int. Cl. F16K 11/07

(52) U.S. Cl. 137/625.69

(57) ABSTRACT

A control device for controlling the movements in a multi-way valve for driving a cylinder-piston assembly provides that with the control stem (5) of a multi-way valve, which can be actuated by a vehicle driver, is coupled a control stem (105) of an auxiliary device, that the stem (105) is operatively coupled to a tubular body (24), urged by a pressure spring, that the tubular body (24) is operatively coupled to a rotary selector and that the tubular body (24) comprises longitudinal slots (33) and circumferential slots (25, 26 and 27), which slots can be engaged by a ball (28) housed in a circumferential chamber (30) of a further tubular element (29) arranged at a radially outer position.

### BACKGROUND OF THE INVENTION

The present invention relates to a control device for controlling the movements in a multi-way valve for driving a cylinder-piston assembly.

As is known, earthmover machines, and agricultural machines, such as tractors, conventionally comprise valves affecting hydraulic pistons, which are designed for driving, for example, a bucket or operating assemblies supported at the rear of a tractor, such as turning over devices, plows, mowing devices and the like.

In order to control from the vehicle driving cab the above mentioned devices, hydraulic pistons are provided, the delivery, respectively return pipe thereof, is coupled to a driving or control valve, for example a fourth-way valve, conventionally supplied by a valve maker.

Inside the vehicle driving cab, a control lever is moreover provided, by which the multi-way valve can be brought to a position suitable to provide the involved device with a raising stroke, a further position of said lever allowing said valve to be brought to a position allowing the device to be lowered and, in a first position of the valve, the device being adapted to be subjected to a floating movement.

In this prior system, the control operations exclusively depend on the driver skillness, who not only must accurately drive the vehicle but, moreover, must also bring, with a very high sensitivity or accuracy, the multi-way valve to a precise target position, with the danger of performing erroneous handlings.

### SUMMARY OF THE INVENTION

Accordingly, the aim of the present invention is to provide an auxiliary control device, to be associated with a multi-way valve of a per se known type, arranged for a hydraulic circuit, for preventing the vehicle driver from freely operating the control lever controlling the valve and in which, by controlled movements of said lever, it is possible to lock said valve at a plurality of preselected positions.

The above aim is achieved by a control device for controlling movements in a multi-way valve, designed for driving a cylinder/piston assembly, characterized in that to the control stem of a multi-way valve, adapted to be actuated by the vehicle driver, is coupled an additional control stem of an auxiliary device, that the additional control stem is operatively coupled to a tubular body, urged by a pressure spring, that the tubular body is operatively coupled to a rotary selector and that said tubular body comprises longitudinal slots and circumferential slots therewith a ball can be engaged, said ball being housed in a circumferential chamber of a further tubular element arranged at a radially outer position.

Further advantages of the invention are defined in the dependant claims.

### BRIEF DESCRIPTION OF THE DRAWINGS

The subject matter of the present invention will be disclosed in a more detailed manner hereinafter with reference to an exemplary embodiment thereof which is illustrated in the accompanying drawings, where:

FIG. 1 shows a hydraulic piston and related driving circuit, together with the control valve 4 including the selector device 7 according to the present invention;

FIG. 2 shows, by a perspective view, the selector device;

FIG. 3 shows, by a further perspective view, the front side of the selector device;

FIG. 4 shows, by a further partially broken-away perspective view, the selector device;

FIG. 5 shows, by a further perspective view, a control sleeve arranged inside the selector device;

FIGS. 6, 7, 8 and 9 show, in axial cross-section, the selector device in different operating positions thereof; and

FIG. 10 shows, by a partially cross-sectioned perspective view, the valve.

### DESCRIPTION OF THE PREFERRED EMBODIMENT

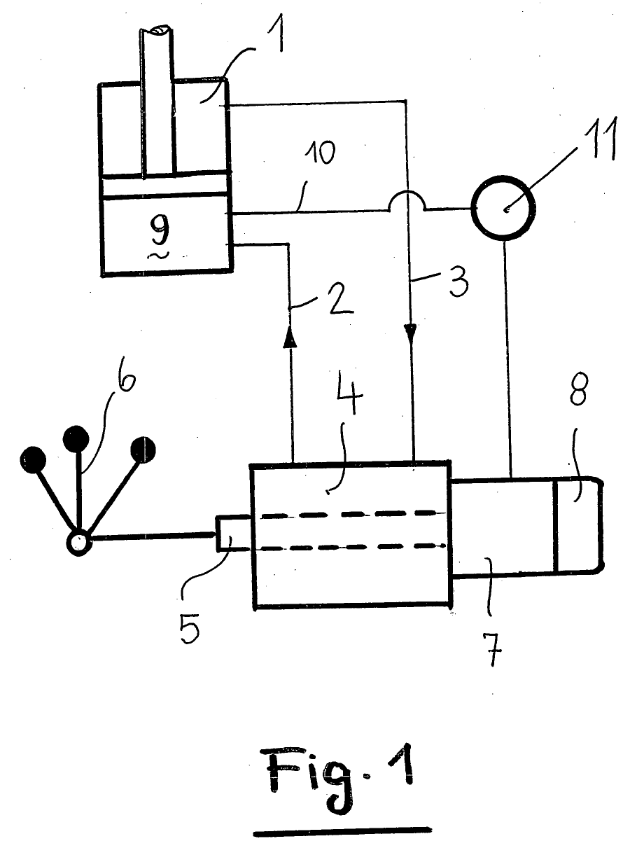

As shown in FIG. 1, the hydraulic assembly comprises a driving piston 1, to which a delivery duct 2 and a return duct 3, for a hydraulic fluid, are coupled.

The ducts 2 and 3 are operatively coupled to a multi-way valve 4 having a control stem 5 which can be driven by a control rod 6 arranged inside the vehicle drive cab, said control rod 6 being shown in FIG. 1 in three different positions thereof.

To the stem 5 of the valve 4 is operatively coupled the stem 105 of a selector device 7 which will be disclosed in a more detailed manner hereinafter. The selector device 7 comprises a rotary selector element 8 which will be also disclosed in a more detailed manner hereinafter.

The chamber 9 of the piston 1 is coupled to a further duct 10 extending toward the device 7 and including a device for setting a maximum operating pressure, such as a pressure gauge 11.

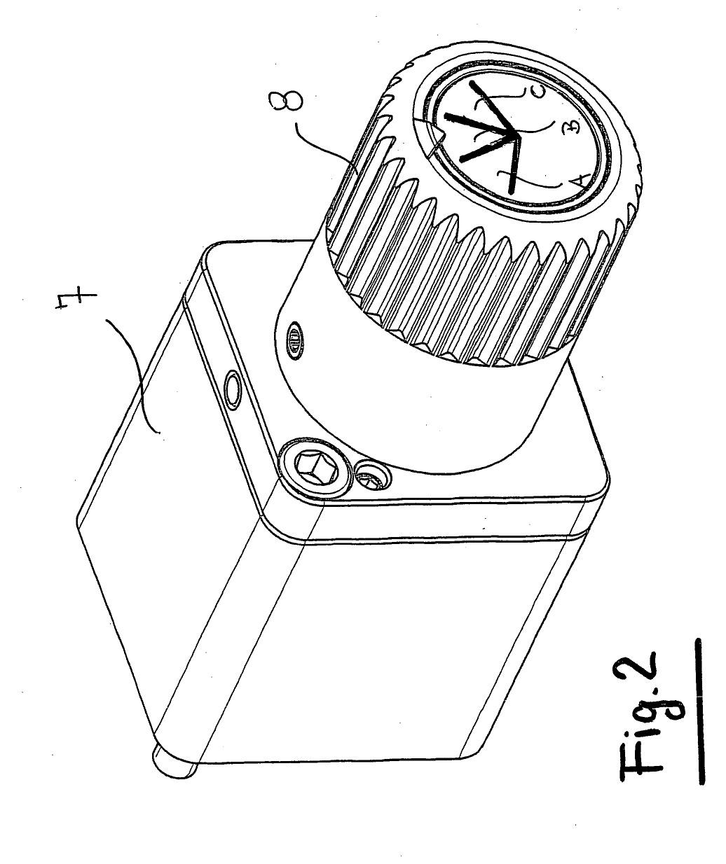

FIG. 2 shows in perspective view the selector or adjusting device 7 as well as the selector element 8 in the form of a rotary knob, designed for defining accurate positions to be assumed by the valve stem 5.

Said knob 8, in particular, can be brought to different positions as indicated by A, B and C.

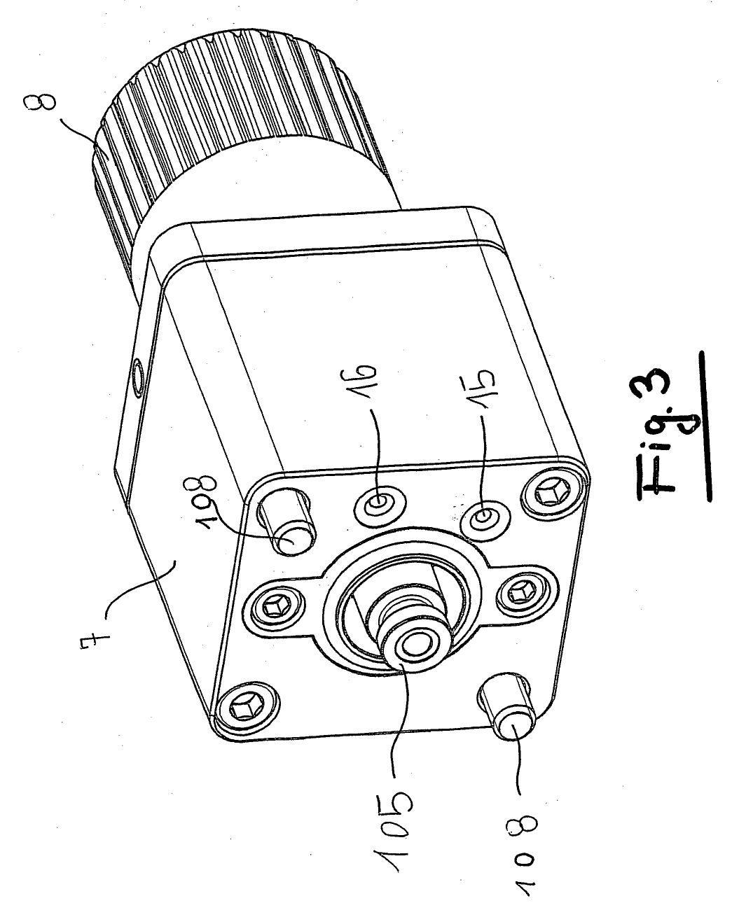

FIG. 3 shows, by a further perspective view, the adjusting device 7 together with its setting knob 8.

From the front side of said device 7, coupling means 108 allowing a connection with the body of the valve 4 project. Moreover, it is possible to see the front portion of the control stem 105 which will be disclosed in a more detailed manner hereinafter.

On the front side of the device 7 an opening 15 and a further coupling opening 16, which will be disclosed in a more detailed manner hereinafter, are provided.

The opening 15 operates as an inlet for the pressure X of the fluid inside the multi-way valve 4.

The opening 16, in turn, constitutes an outlet for the pressure Y, present inside the valve, to be supplied to the control sensor 11.

Inside the device 7 is housed said control stem 105 which, at its rear end portion receives a resilient ring element 20 operating as a detent or stop means for a bracket 21 thereagainst is abutted a spring 22 abutting against a further bracket 23 in turn abutting against a tubular body 24.

The tubular body 24 encompasses the stem 105 and is urged, through said bracket 23, by a preloaded spring 22.

The tubular body 24 comprises a plurality of circumferential slots 25, 26, 27 which can be contacted by a ball 28 housed in a further tubular element 29 which outward radially projects.

The tubular element 29 is encompassed by a further tubular element 100 which, on the side thereof facing said ball 28, comprises a circumferential chamber 30 delimited by a slanted surface 31.

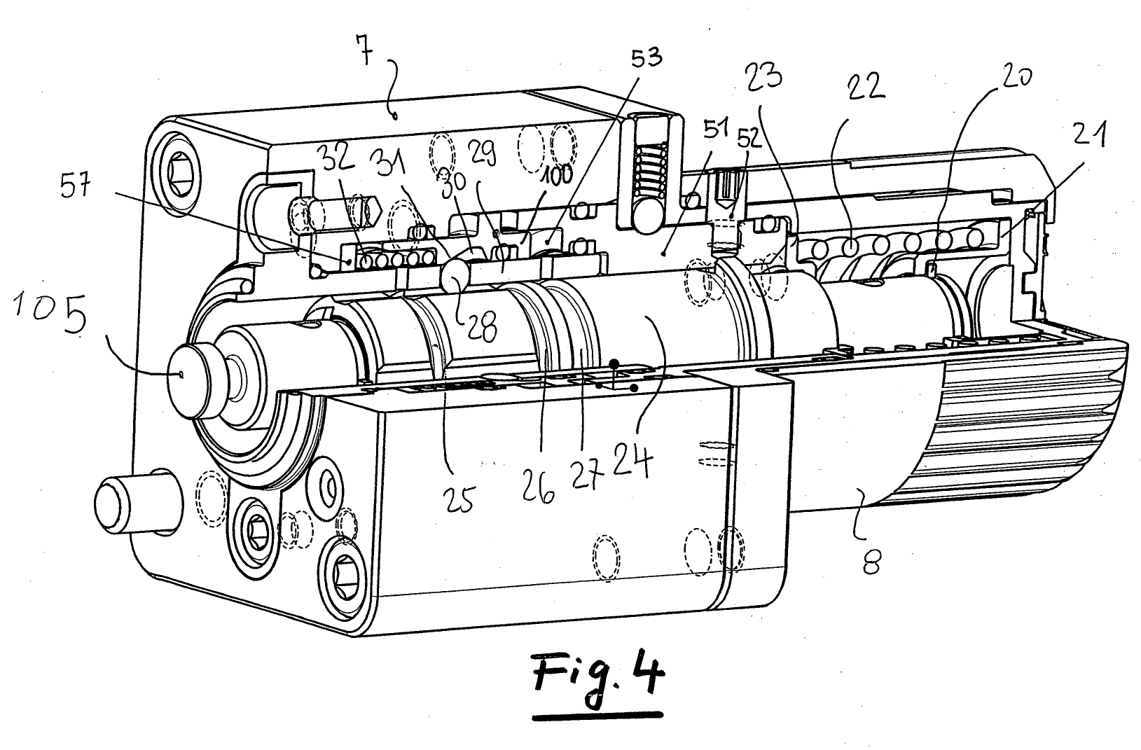

The tubular body 100 is preloaded by a preloading spring 32 and by a ring element 57 (FIG. 4) which is urged by the fluid pressure supplied through the hole 16 formed through the body 7 (FIG. 3) and directly derived from the valve 4 in turn coupled to the hydraulic pump of the system.

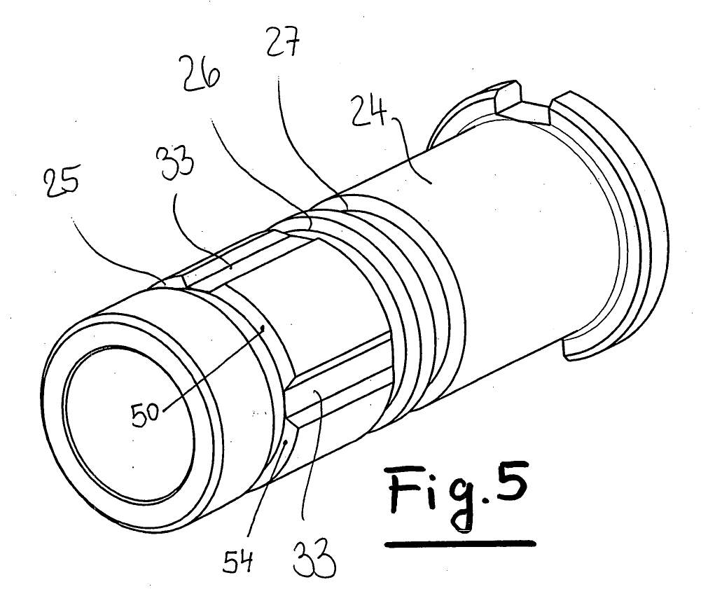

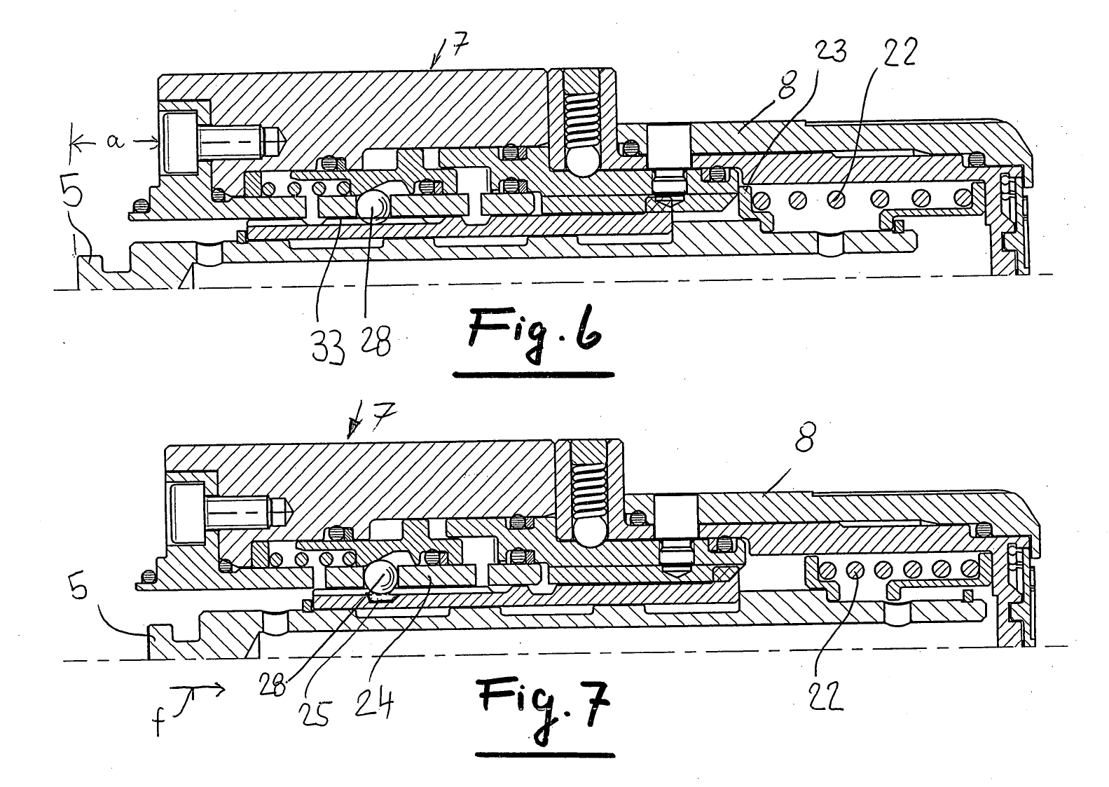

The calibration of the spring 32 and the inclinations of the recesses shown in FIG. 5 causes the overall system to snap assume a neutral position, as shown in FIG. 6, as the pressure supplied through the hole 15 drops to zero MPa, independently from the position of the stem 105, as shown in FIGS. 7, 8 and 9.

As is clearly shown in FIG. 5, the tubular body 24 further comprises, in addition to the circumferential slots 25, 26 and 27, a plurality of longitudinal channels 33, allowing the tubular body 24 to be axially driven.

FIGS. 6, 7, 8 and 9 show different operating positions of the device 7 and related knob 8.

In FIG. 6, the spring 22 is shown in a maximally expanded condition, and it presses, through the bracket 23, on the body of the stem 105. In this position, the tubular element can freely move, owing to the provision of the longitudinal slot 33.

In FIG. 7, the stem, indicated by 105, has been driven in the direction shown by the arrow (f) thereby pressing the spring 22 and receiving in the circumferential slot 25 the ball 28.

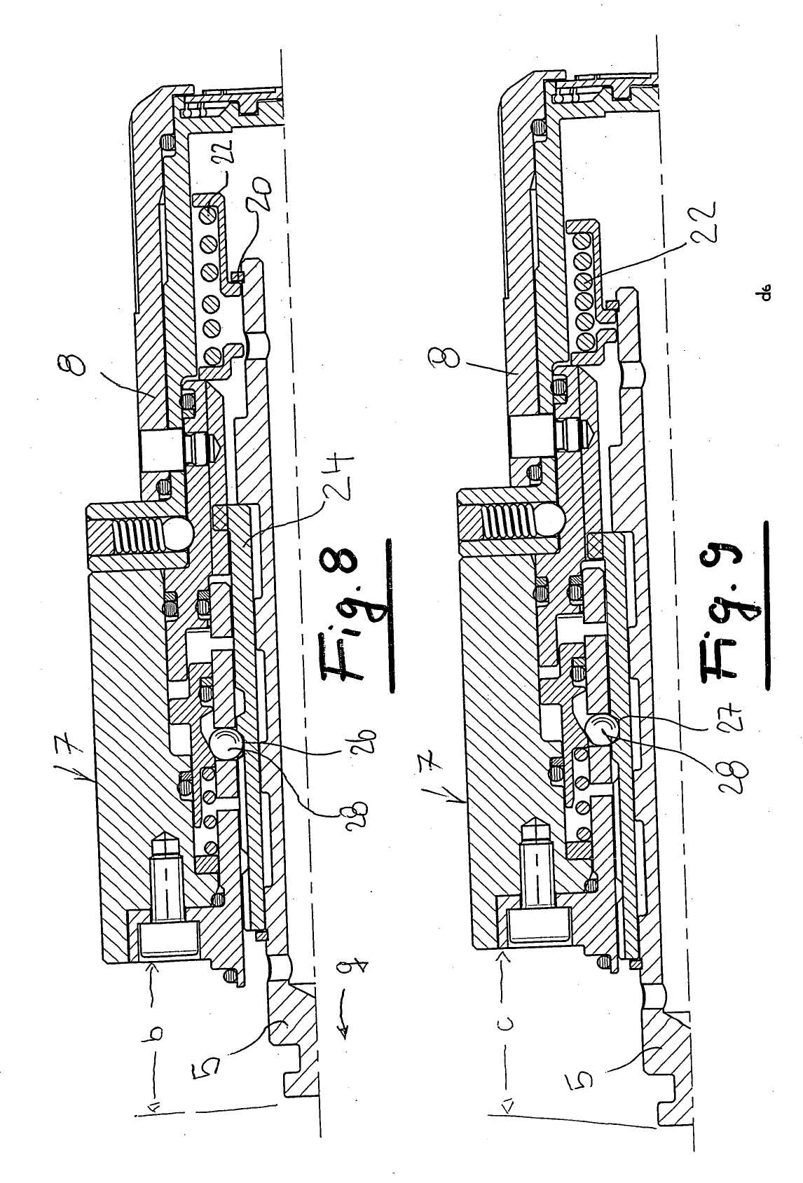

In FIG. 8, said stem 105 has been driven in the direction indicated by the arrow (g), thereby causing the ball 28 to enter the circumferential slot 26, and causing the detent ring 20 to contact the spring 22.

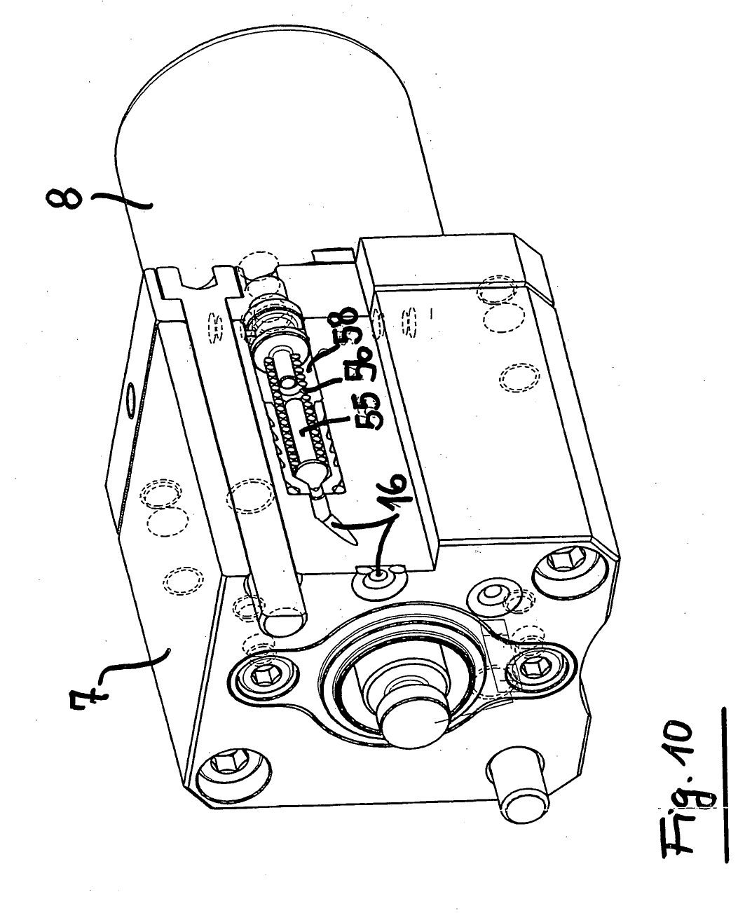

In FIG. 9, the stem 105 has been further displaced from the device 7 and the ball 28 engaged in the circumferential slot 27. In such a position, the spring 22 is maximally pressed.

The operation of the device can be clearly understood from FIGS. 6, 7, 8 and 9.

In FIG. 6, the ball 28 is arranged in the slot 33 and, accordingly, the valve shaft or stem 5 can perform an axial floating movement, whereas the stem 105 can project from the device 7 for a distance (a) given by way of an example.

In FIG. 7, the stem 105 has been withdrawn inside the body of the device 7, thereby causing the ball 28 to engage with the circumferential slot 25, to lock the stem 5 in this position.

In the position shown in FIG. 8, the ball 28 has been engaged in the circumferential slot 27 of the tubular body 24, and the stem 105 of the device 7 projects from said device by an amount (b).

Finally, as shown in FIG. 9, the stem 105 has been further projected for an amount (c) from the body of the device 7.

Since the end portion of the stem 105 is operatively coupled to a multi-way valve, the different positions assumed by said stem 105, as shown in FIG. 7, allow the multi-way valve 4 to accurately and controllably assume the desired positions thereof.

With the selector element 8 arranged in the position (A), as shown in FIG. 4, the tubular element 24 turns about its pivot axis through 45° owing to the provision of the element 51, thereby causing the balls 28 to abut against the abutment wall 50; thus, the stem 105 will be locked at one of the three positions shown in FIGS. 7, 8 and 9.

With the selector element 8 arranged in the position (B), as shown in FIG. 2, the tubular element 24 further pivots about its pivot axis through 45° also due to the element 51 coupled to the selector element 8 by the screws 52, thereby bringing the balls 28 into the longitudinal slot 33; thus the stem 105 will be held engaged in its position only if the balls 28 drop into the slot or groove (FIG. 9).

With the selector element 8 arranged in the position (C), as shown in FIG. 2, the tubular element 24 turns through further 45°, thereby the balls 28 will abut against the slanted surface 54, to allow the stem 105 to be held engaged in all the three positions shown in FIGS. 7, 8 and 9.

The characteristic of the function (C) is that, as a maximum pressure is delivered by the line 10 (FIG. 1), the valve 55, urged by the spring 56, will be axially displaced under the pressure supplied through the hole 16 (FIG. 3), which pressure is released in the chamber 53 (FIG. 4) (owing to the angular position of the element 51 communicating the chamber 53 with the chamber 58), thereby causing the tubular element 100 to move leftward, and freeing the balls 28. Thus, the stem 105 will return to its neutral position, as shown in FIG. 6.

1. A control device for controlling the movements in a multi-way valve, designed for driving a cylinder-piston assembly, characterized in that to a control stem (5) of said multi-way valve (4), adapted to be actuated by a driver (6) of a vehicle, is coupled a further control stem (105) of an auxiliary device (7), that said stem (105) is operatively coupled to a tubular body (24), urged by a pressure spring (22), that said tubular body (24) is operatively coupled to a rotary selector element (8) and that said tubular body (24) comprises a plurality of longitudinal slots (33) and circumferential slots (25, 26 and 27), therewith a ball (28) housed in a circumferential chamber (30) of a further tubular element (29) arranged in a radially outer position, can be engaged.
